(19) United States
(12) Patent Application Publication
(10) Pub. No.: US 2009/0001626 A1
(43) Pub. Date: Jan. 1, 2009

(54) PROCESS FOR THE PRODUCTION OF POLYURETHANE MOLDED ARTICLES

(75) Inventors: Hans-Guido Wirtz, Leverkusen (DE); Achim Symannek, Leichlingen (DE); Reiner Paul, Leichlingen (DE); Dirk Wegener, Monheim (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/206,366

(22) Filed: Sep. 8, 2008

Related U.S. Application Data
(62) Division of application No. 11/157,059, filed on Jun. 20, 2005.

(30) Foreign Application Priority Data
Jun. 22, 2004 (DE) 10 2004 030 196.4

(51) Int. Cl. B29C 65/02

(52) U.S. Cl. 264/46.5

(57) ABSTRACT

The present invention relates to a process for the production of polyurethane molded articles in which the polyurethane-forming mixture applied to reinforcing fiber layer(s) or a reinforcing fiber mat includes a gas and a foam stabilizer. These molded articles are useful in automotive and construction applications and in furniture.

### BACKGROUND OF THE INVENTION

The present invention relates to a process for the production of polyurethane (PU) molded articles, in particular PU sandwich structural parts, and their use.

Processes for the production of sandwich elements for the fabrication of flat sheets have been known for some time. The sandwich construction is made up of a light and compression-resistant core with high-strength covering layers. This composite structure is formed by a PU reaction mixture which, when applied on both sides in a thermal compression molding process, can form an indissoluble bond. The inner core layer of the sandwich structure is preferably made up of cardboard with a honeycomb structure, which during the compression procedure acts as a spacer for the covering layers wetted with PU. The wetting of the sandwich covering layers is preferably effected by spraying. The substrate carrier is in this case robot-guided, and during the PU application by means of a mixing head is arranged in the horizontal or preferably in the vertical position, since in this orientation a double-sided application can be carried out at the same time. Also, the polyurethane mixing head can be guided by a robot.

Three-dimensional molded articles can also be produced due to the combination of compression and shaping processes. The honeycomb core, which for sheet materials is built up over the whole surface to a uniform thickness a few tenths of a millimeter thick, is now compressed in partial regions to a small percentage of its original size. The shaping of the outer contour of the finished part is effected by a nipping-off of the sandwich structure by pinch edging in the shaping tool (mold), so that the structural part has closed outer edges after removal from the mold. In this shaping process, a three-dimensional structural part is obtained that has unlaminated visible surfaces and also unlaminated visible edges.

The previous processes for the production of PU molded articles, in particular PU sandwich structural parts, provide three-dimensional parts with a poor edge definition and/or insufficient material infilling. Especially in the case of highly contoured articles, the edge definition is generally unsatisfactory. In addition, the amount of polyurethane that can be applied is restricted, since the applied liquid polyurethane mixture tends to drip.

### SUMMARY OF THE INVENTION

The object of the present invention is to provide a process that enables three-dimensional PU articles with good edge definition to be produced in a simple way.

This object is surprisingly achieved if the polyurethane mixture being applied is charged with a gas and also contains a foam stabilizer.

### BRIEF DESCRIPTION OF THE DRAWINGS

FIG. 1 illustrates a molded article produced by the process of the present invention as described in Example 1.

FIG. 2 illustrates a molded article produced by the prior art process described in Example 2.

FIG. 3 is a picture in which a molded part produced in accordance with the present invention as described in Example 3 (designated Section B) is positioned next to a molded part produced in accordance with the prior art as described in Example 4 (designated Section A).

### DETAILED DESCRIPTION OF THE INVENTION

The present invention provides a process for the production of polyurethane molded articles, in which

a) a polyurethane-forming mixture is added to the reinforcing fiber layers of a sandwich of at least one core layer (inner layer) and two reinforcing fiber covering layers or to a reinforcing fiber mat,
b) the sandwich or reinforcing fiber mat from a) is placed in a mold,
c) shaping the mold contents at a mold temperature between 40° and 160° C. and while hardening the polyurethane-forming mixture to form a molded article,
d) removing the molded article produced in c) from the mold, and
e) optionally, post-treating the molded article.

At least some portion of the polyurethane-forming mixture added to the reinforcing fiber covering layers or reinforcing fiber mat, must be charged with a gas and also contain a foam stabilizer. Molded articles having good edge definition are obtained by this process. In addition, it is possible to increase the amount of polyurethane proportionately to the application surface and prevent or at least minimize run-off or dripping.

In a preferred embodiment of the process of the present invention, in the addition to the polyurethane mixture, chopped fibers are also applied over part or over the whole of the surface of the reinforcing fiber covering layers or reinforcing fiber mat. Bonding of these additionally applied, chopped fibers wetted with PU takes place.

Air, nitrogen and CO₂ are preferably used gases.

The incorporation of the gas may be carried out by any of the known methods, such as, e.g., batch or online methods.

Suitable foam stabilizers include any of those known to those skilled in the art. Examples of particularly preferred foam stabilizers are polyether siloxanes, particularly those which are water-soluble. The preferred stabilizer compounds are generally synthesized in such a way that a copolymer of ethylene oxide and propylene oxide is bonded to a polydimethylsiloxane residue. Such foam stabilizers are described, for example, in U.S. Pat. Nos. 2,834,748; 2,917,480 and 3,629,308. Of particular interest are polysiloxane-polyoxyalkylene copolymers multiply branched via allophanate groups such as those described in DE-OS 25 58 523. Also suitable as foam stabilizers are other organopolysiloxanes, oxyethylated alkylphenols, oxyethylated aliphatic alcohols, paraffin oils, castor oil esters and castor oil acid esters, Turkey Red oil and groundnut oil, and cell regulators such as paraffins, aliphatic alcohols and dimethylpolysiloxanes For improved emulsifying effect, cell structure and/or stabilization, oligomeric polyacrylates with polyoxyalkylene residues and fluoroalkane residues as side groups may be used. The foam stabilizer is generally used in an amount of from 0.01 to 5 parts by weight, per 100 parts by weight of the polyol.

The polyurethane-forming mixture used in the process of the present invention will generally include

A) at least one polyol component with an average OH number of 300 to 700, which includes at least one short-chain and one long-chain polyol, the individual polyols having a functionality of 2 to 6,
B) at least one polyisocyanate,
C) optionally, a blowing agent,
D) an activator, as well as
E) optional auxiliary substances, mold release agents and additives.

Suitable polyols which may be included in the polyol component are polyols with at least two H atoms reactive to isocyanate groups. Polyester polyols and polyether polyols are preferably used.

According to the invention there are preferably used higher-nuclear isocyanates of the diphenylmethane diisocyanate series (pMDI types), their prepolymers or crude MDI.

As blowing agents C) there may generally be used chemically or physically acting compounds. As chemically acting blowing agent there may preferably be used water, which forms carbon dioxide by reaction with the isocyanate groups. Examples of physical blowing agents are (cyclo)aliphatic hydrocarbons, preferably those with 4 to 8, more preferably 4 to 6 and most preferably 5 carbon atoms, partially halogenated hydrocarbons, or ethers, ketones or acetates. A blowing effect can also be achieved by adding compounds that decompose at temperatures below room temperature with the evolution of gases. The various blowing agents may be used individually or in mixtures with respect to one another.

Suitable catalysts include the conventional activators for the blowing and crosslinking reaction, such as, for example, amines and metal salts.

Other auxiliary substances, mold release agents and additives may optionally be incorporated in the reaction mixture. Examples of such additives include surface-active additives such as emulsifiers, flame retardants, nucleation agents, antioxidants, lubricants and mold release agents, colorants, dispersion aids and pigments.

The isocyanate and polyol components are generally reacted in amounts such that the ratio of equivalents of NCO groups of the polyisocyanate to the total equivalents of the hydrogen atoms of the remaining components reactive to isocyanate groups is from 0.8:1 to 1.4:1, preferably from 0.9:1 to 1.3:1.

The core layer is preferably a thermoformable polyurethane foam, paper, metal or a plastic honeycomb. Suitable fiber materials include glass fiber mats, glass fiber non-wovens, glass fiber random structures, glass fiber tissues, chopped or ground glass or mineral fibers, natural fiber mats and knitted fabrics, chopped natural fibers and fiber mats, fiber non-wovens and knitted fabrics based on polymer fibers, carbon fibers or aramide fibers, as well as mixtures thereof.

The sandwich used in step a) is normally produced in such a way that a reinforcing fiber covering layer is applied to both sides of the core layer. A polyurethane-forming two-component mixture (so-called isocyanate and polyol component) is then added. At the same time that the polyurethane-forming mixture is added, chopped fibers may also preferably be applied over the whole or part of the surface.

If a reinforcing fiber mat is used in step a), the mat is first taken and impregnated in a conventional way with a polyurethane-forming mixture. In this case, two chopped fibers may additionally be applied at the same time over the whole or part of the surface.

The PU molded articles produced in accordance with the present invention may, after removal from the mold, be laminated with covering layers or decorative substances in a subsequent step according to known processes. If suitable covering layers or decorative substances are used, the bonding to the PU molded article may already take place during the production step by first of all taking the covering layer or decorative substance and at the same time compressing it with the sandwich structure or reinforcing fiber mat in the mold. As decorative materials there may in this connection be used textiles blocked against impregnation with polyurethane, compact or foamed plastics films, as well as spray skins or RIM skins of polyurethane. As covering layers there may also be used preformed materials suitable for external applications, such as metal foils or sheets, as well as compact thermoplastic composites of PMMA (polymethyl methacrylate), ASA (acrylic ester-modified styrene-acrylonitrile terpolymer), PC (polycarbonate), PA (polyamide), PBT polybutylene terephthalate) and/or PPO (polyphenylene oxide) in painted, paintably prepared or colored form. As covering layers there may likewise be used continuously or batchwise-produced covering layers based on melamine-phenol, phenol-formaldehyde, epoxy or unsaturated polyester resins.

The PU molded articles produced in accordance with the present invention are preferably used as structural parts or lining/cladding parts, in particular for the automobile industry, furniture industry and building and construction industry. The invention will be discussed in more detail with the aid of the following examples.

### EXAMPLES

### Starting Materials

Polyol 1: Polyether polyol of OH number 865, produced by addition of PO to trimethylolpropane.

Polyol 2: Polyether polyol of OH number 1000, produced by addition of PO to trimethylolpropane.

Polyol 3: Polyether polyol of OH number 42, produced by addition of 86% PO and 14% EO to propylene glycol as starter.

Polyisocyanate: Polymeric MDI with an isocyanate content of 31.5 wt. % which is commercially available under the name Desmodur 44 V 20L from Bayer Material Science AG.

Stabilizer: Silicone stabilizer which is commercially available under the name Polurax® SR 242 from Osi Crompton Witco Specialities, D 60318 Frankfurt, Humboldstr. 12.

Catalyst: Amine catalyst which is commercially available under the name Thancat® AN10 from Air Products GmbH, D-45527 Hattingen.

Colorant: Baydur® black paste DN which is commercially available from Bayer Material Science AG.

### Polyurethane Formulations:

### Formulation 1:

A Component

| | | |
|---|---|---|
| Polyol 1 | 30.0 | parts by weight |
| Polyol 2 | 20.0 | parts by weight |
| Polyol 3 | 33.0 | parts by weight |
| Catalyst | 2.8 | parts by weight |
| Stabilizer | 1.3 | parts by weight |
| Acetic acid | 0.3 | parts by weight |
| Water | 1.4 | parts by weight |
| Colorant | 3.3 | parts by weight |

B Component

| | | |
|---|---|---|
| Polyisocyanate | 140.0 | parts by weight |

The polyol mixture (Polyols 1, 2 and 3) has an average OH number of 568 mg KOH/g.

### Formulation 2:

A Component

| | | |
|---|---|---|
| Polyol 1 | 30.0 | parts by weight |
| Polyol 2 | 20.0 | parts by weight |
| Polyol 3 | 33.0 | parts by weight |
| Catalyst | 2.8 | parts by weight |
| Acetic acid | 0.3 | parts by weight |
| Water | 1.4 | parts by weight |
| Colorant | 3.3 | parts by weight |

B Component

| | | |
|---|---|---|
| Polyisocyanate | 140.0 | parts by weight |

The polyol mixture (Polyols 1, 2 and 3) has an average OH number of 568 mg KOH/g.

### Example 1

### According to the Invention

The A Component of Formulation 1 was charged with gaseous CO₂ using a star-shaped type hollow-shaft stirrer. After charging, a polyol density of 420 kg/m³ was measured by liter gauging.

Chopped glass fiber were applied in an area weight of 450 g/m² to both sides of a core layer consisting of a paper honeycomb of corrugated cardboard 5/5 type 10 mm thick and spray-coated at room temperature with a total of 450 g/m² of the polyurethane Formulation 1 charged with CO₂.

This sandwich was placed in a sheet-forming mold, into which a sharp-edged flat piece of steel of size 6×30×300 mm had previously been inserted for the shaping. The sandwich was then compressed to a wall thickness of 9.8 mm, in the mold heated to 130° C., the sandwich having been more strongly compressed to a wall thickness of 3.8 mm in the region of the flat steel insert.

The more strongly compressed region had a sharp edge definition, as shown in FIG. 1.

### Example 2

### Comparison

The experiment described in Example 1 was repeated, except that the Formulation was not charged with CO₂.

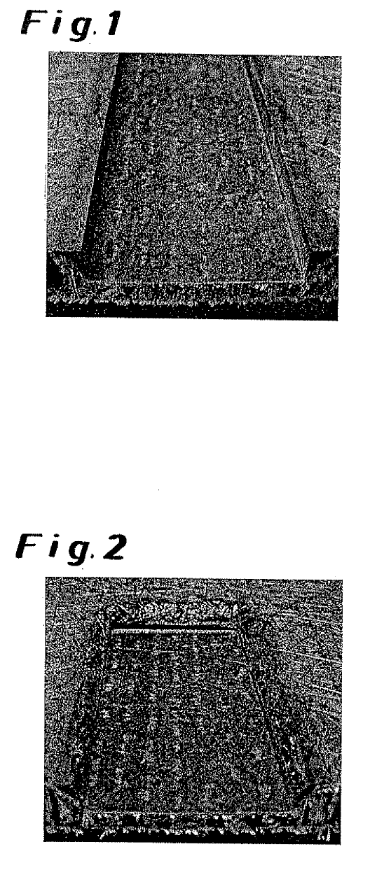

The more strongly compressed region had a defective edge definition, as shown in FIG. 2.

### Example 3

### According to the Invention

The polyurethane-forming Formulation 1 was charged as in Example 1 with gaseous CO₂.

Chopped glass fibers were applied in an area weight of 450 g/m² to both sides of a core layer consisting of a paper honeycomb of corrugated cardboard 5/5 type 40 mm thick and spray-coated at room temperature with 550 g/m² of the polyurethane Formulation 1 charged with CO₂. In addition, during the spraying, chopped glass fibers of the type 816, 2400 tex/Mühlmeier, were applied by means of a cutter, type SW 2/Wolfangel, in the region of the subsequent shaping.

This sandwich was placed in a sheet-forming mold, that permitted the formation of a 35 mm high, cylindrical dome of 50 mm diameter through a corresponding depression in the upper part of the mold. The sandwich was then compressed to a wall thickness of 17 mm in the mold heated to 130° C., the region of the dome being correspondingly less markedly compressed.

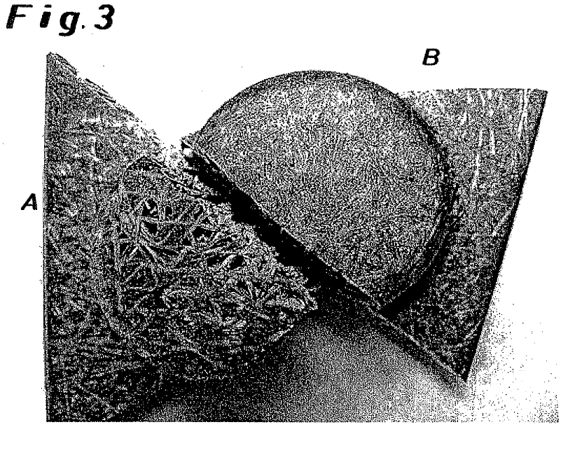

The dome that was formed had the closed surface shown in FIG. 3, section B.

### Example 4

### Comparison

The experiment of Example 3 was repeated, except that the Formulation 1 was not charged with CO₂ and no additional glass fibers were added.

The dome that was formed had the open, undesirable surface shown in FIG. 3, section A.

### Example 5

### Comparison

The experiment of Example 3 was repeated, but without the addition of CO₂ to the Formulation 1.

Due to the poor adhesion behavior of the polyurethane mixture, the additionally applied chopped glass fibers fell down up to the insertion of the sandwich charged with polyurethane.

### Example 6

### Comparison

The experiment of Example 1 was repeated, except that the Formulation 2 was used instead of the Formulation 1.

The more strongly compressed region had a defective edge definition (similar to that shown in FIG. 2).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for producing polyurethane molded articles comprising:
a) adding a polyurethane-forming mixture which includes a foam stabilizer and a gas to a part comprising (1) a sandwich comprising at least one core layer and two reinforcing fiber covering layers or (2) a reinforcing fiber mat;
b) placing the part from a) in a mold;
c) maintaining the mold at a temperature in the range of from 40° C. and 160° C. to mold the part and harden the polyurethane-forming mixture and thereby form a molded article;
d) removing the molded article produced in c) from the mold; and
e) optionally, post-treating the molded article.

2. The process of claim 1, wherein chopped fibers are also added to at least a portion of the part during a).

3-8. (canceled)
